(19) United States
(12) Patent Application Publication
(10) Pub. No.: US 2016/0297489 A1
(43) Pub. Date: Oct. 13, 2016

(54) BICYCLE SADDLE SELECTING METHOD

(71) Applicant: VELO ENTERPRISE CO., LTD., Taichung City (TW)

(72) Inventor: Tsai-Yun YU, TAICHUNG CITY (TW)

(21) Appl. No.: 14/946,826

(22) Filed: Nov. 20, 2015

(30) Foreign Application Priority Data
Apr. 13, 2015 (TW) 104111841

(51) Int. Cl. B62J 1/00

(52) U.S. Cl. CPC B62J 1/00

(57) ABSTRACT

A bicycle saddle selecting method includes the steps of classifying bicycle saddles having various specifications into a plurality of groups and setting a plurality of scales for each of a plurality of sorting indexes including a bicycle type, a frequency of riding, and at least one of a speed of riding and a distance of riding, selecting one of the scales for each of the sorting indexes according to usage requirements, and sorting a fitting group from the groups by the selected scales of the sorting indexes.

### BACKGROUND OF THE INVENTION

1. Field of the Invention

The present invention relates generally to bicycle saddles and more particularly, to a bicycle saddle selecting method.

2. Description of the Related Art

There are more and more people riding bicycles and requiring better and better performance of the whole bicycle or some accessories of the bicycle. For various usage requirements, the dealers in the bicycle saddle industry continuously improve and innovate the bicycle saddles in many aspects such as shape, hardness, elasticity, and so on, so that there are more and more varieties in the commercially available bicycle saddles. As a result, various users all have the chance to pick out the bicycle saddle which completely conforms to the personal usage requirements of the users. However, too many options of bicycle saddle bring the selectors, including the end consumers and the dealers in the bicycle selling industry, a certain confusion and time-consumption in making a selection from the numerous available bicycle saddles.

### SUMMARY OF THE INVENTION

The present invention has been accomplished in view of the above-noted circumstances. It is an objective of the present invention to provide a bicycle saddle selecting method, through which the process of selecting the bicycle saddle is relatively easier and time-saving.

To attain the above objective, the present invention provides a bicycle saddle selecting method which comprises the steps of:

a) classifying bicycle saddles having various specifications into a plurality of groups, and setting a plurality of scales for each of a plurality of sorting indexes including a bicycle type, a frequency of riding, and at least one of a speed of riding and a distance of riding;

b) selecting one of the scales for each of the sorting indexes according to usage requirements; and

c) sorting a fitting group from the groups by means of the selected scales of the sorting indexes in the step b).

In other words, the sorting indexes may comprise the speed of riding without the distance of riding. Alternately, the sorting indexes may comprise the distance of riding without the speed of riding. Alternately, the sorting indexes may comprise both the speed of riding and the distance of riding.

In an embodiment of the present invention, the sorting index of the bicycle type is set with five scales, which respectively correspond to the bicycle types of: kid bicycle, city bicycle, sport bicycle, mountain bicycle, and road bicycle; the sorting index of the frequency of riding is set with five scales, which respectively correspond to the frequencies of riding of random manner, monthly manner, weekly manner, twice a week, and daily manner; the sorting index of the speed of riding is set with five scales, which respectively correspond to the speed ranges of: 0-15 kilometers per hour, 15-20 kilometers per hour, 20-30 kilometers per hour, 30-40 kilometers per hour, and 40-50 kilometers per hour; the sorting index of the distance of riding is set with five scales, which respectively correspond to the distance ranges of: less than 5 kilometers, 5-15 kilometers, 15-30 kilometers, 30-50 kilometers, and 50-100 kilometers or more than 100 kilometers.

The sorting indexes may, but not limited to, further comprise skill of riding. The scale selected for the skill of riding in the step b) may be derived from self-estimation of a user. Alternately, the scales of the skill of riding may be specifically set according to another index related to the skill of riding. For example, the sorting index of the skill of riding may be set with the scales according to user identities, and may be set with five scales, which respectively correspond to the user identities of: kid, adult, athlete, amateur contestant, and professional contestant. Alternately, the sorting index of the skill of riding may be set with the scales according to experience of riding, and may be set with five scales, which respectively correspond to the experience of riding of: no experience, less than two years, two to five years, five to ten years, and more than ten years.

Besides, each of the scales of the sorting indexes may correspond to a numerical value. In the step c), a sorting value may be obtained by summing or averaging the numerical values of the selected scales of the sorting indexes in the step b), and the sorting value is used to sort the fitting group from the groups. For example, the aforesaid five scales of each sorting index may correspond to the numerical values of 1-5, and the sorting value obtained by averaging the numerical values of the selected scales of the five sorting indexes is ranged from one to five. Each of the groups of bicycle saddles is set beforehand to correspond to a numerical number or a numerical range in the range from one to five, so that the sorting value can correspond to the numerical number or numerical range of one of the groups, which is accordingly considered as the fitting group.

In this way, the selector, no matter the end consumer or the dealer in the bicycle selling industry, only needs to select the most conformable bicycle saddle with the usage requirements from the fitting group sorted out by the aforesaid method. This means the selector doesn't need to make the selection from numerous different bicycle saddles. Therefore, the process of selecting the bicycle saddle is relatively easier and time-saving through the bicycle saddle selecting method of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a radar chart showing a bicycle saddle selecting method according to a preferred embodiment of the present invention.

### DETAILED DESCRIPTION OF THE INVENTION

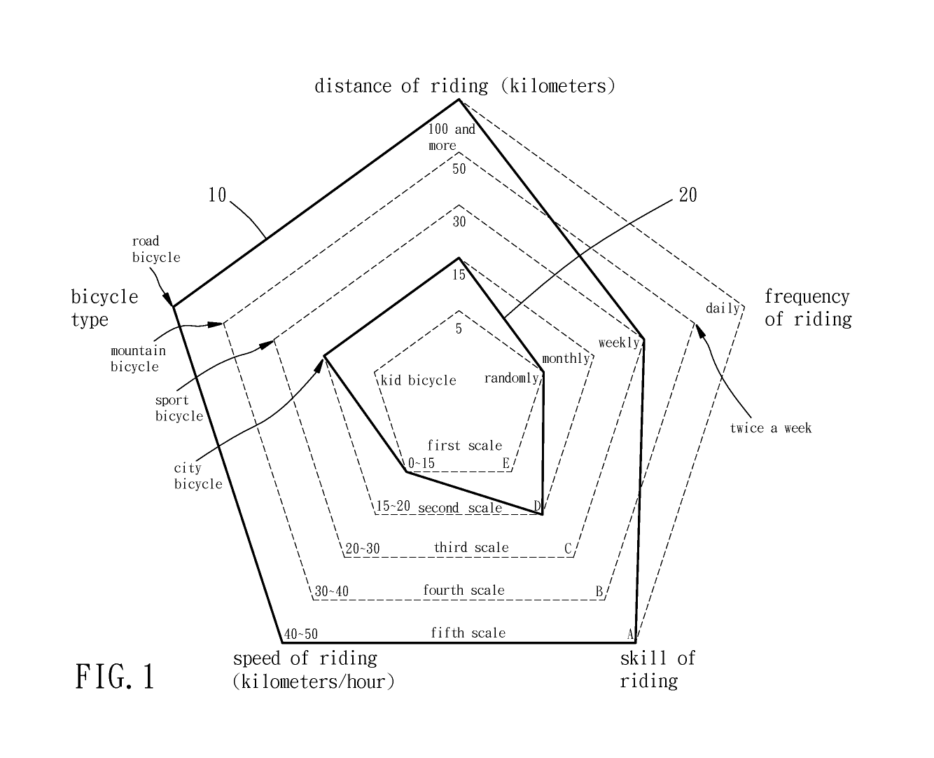

Referring to FIG. 1, a bicycle saddle selecting method according to a preferred embodiment of the present invention comprises the following steps.

a) Classify bicycle saddles having various specifications into a plurality of groups, and set a plurality of scales for each of a plurality of sorting indexes including a bicycle type, a frequency of riding, and at least one of a speed of riding and a distance of riding.

This step is performed by the dealers in the industry of manufacturing or selling the bicycle saddles. The bicycle saddles for sale, which have various specifications, are roughly classified into the aforesaid a plurality of groups, and may be classified according to the properties of the bicycle saddles, such as material, weight, shape, having a shock absorber or not, the capability of the shock absorber, supporting capability, extent of comfort, and so on. Besides, each group may, but not limited to, comprise a plurality of different bicycle saddles, so that the bicycle saddles in the same group have different performance or particulars in specifications. As to the sorting indexes adopted in the step a) and the scales set for the sorting indexes, as shown in FIG. 1, this embodiment adopts the sorting indexes of the bicycle type, the frequency of riding, the speed of riding, the distance of riding and the skill of riding, and each of the sorting indexes is set with five scales, i.e. the first to fifth scales. As shown in the following table 1, each of the scales of the sorting indexes can be set to correspond to a numerical value. Specifically speaking, the first to fifth scales of each sorting index correspond to the numerical values of 1-5, respectively. However, the amount of the scales of each sorting index and the numerical values thereof are not limited to that illustrated in this embodiment.

TABLE 1

| | numerical | bicycle | frequency | speed of | distance of | |
|---|---|---|---|---|---|---|
| scale | value | type | of riding | riding | riding | skill of riding |
| first | 1 | kid | randomly | 0-15 | less than 5 | E |
| | | bicycle | | kilometers | kilometers | |
| | | | | per hour | | |
| second | 2 | city | monthly | 15-20 | 5-15 | D |
| | | bicycle | | kilometers | kilometers | |
| | | | | per hour | | |
| third | 3 | sport | weekly | 20-30 | 15-30 | C |
| | | bicycle | | kilometers | kilometers | |
| | | | | per hour | | |
| fourth | 4 | mountain | twice a | 30-40 | 30-50 | B |
| | | bicycle | week | kilometers | kilometers | |
| | | | | per hour | | |
| fifth | 5 | road | daily | 40-50 | 50-100 | A |
| | | bicycle | | kilometers | kilometers or | |
| | | | | per hour | more than 100 | |
| | | | | | kilometers | |

The first to fifth scales of the sorting index of the bicycle type, i.e. the type of the bicycle used by the user, may, but not limited to, respectively correspond to the bicycle types of: kid bicycle, city bicycle, sport bicycle, mountain bicycle, and road bicycle. The first to fifth scales of the sorting index of the frequency of riding, i.e. the frequency of the user riding the bicycle, may, but not limited to, respectively correspond to the frequencies of riding of random manner, monthly manner, weekly manner, twice a week, and daily manner. The first to fifth scales of the sorting index of the speed of riding, i.e. the usual speed of the user riding the bicycle, may, but not limited to, respectively correspond to the speed ranges of: 0-15 kilometers per hour, 15-20 kilometers per hour, 20-30 kilometers per hour, 30-40 kilometers per hour, and 40-50 kilometers per hour. The first to fifth scales of the sorting index of the distance of riding, i.e. the usual distance of the user riding the bicycle, may, but not limited to, respectively correspond to the distance ranges of: less than 5 kilometers, 5-15 kilometers, 15-30 kilometers, 30-50 kilometers, and 50-100 kilometers or more than 100 kilometers.

b) Select one of the scales for each of the sorting indexes according to usage requirements.

This step is performed by a selector, who may be the end consumer or the dealer in the bicycle selling industry, when the selector picks out the bicycle saddle for purchase purpose. Based on the corresponding contents of the scales of the sorting indexes set by the dealer in the bicycle saddle industry in the step a), the selector select one scale from the five scales for each of the five sorting indexes according to the type of the bicycle used by the user, the frequency of the user riding the bicycle, and the usual speed and distance of the user riding the bicycle in a way that the corresponding contents of the selected scales of the sorting indexes are more conformable with the actual usage requirements than that of the other scales of the sorting indexes.

As mentioned above, in addition to the bicycle type and the frequency of riding, at least one of the speed of riding and the distance of riding is necessarily included in the sorting indexes, which means the amount of the sorting indexes is at least three. In other words, the sorting indexes may comprise the speed of riding but not comprise the distance of riding. Alternately, the sorting indexes may comprise the distance of riding but not comprise the speed of riding. Alternately, the sorting indexes may comprise both the speed of riding and the distance of riding.

It is to be mentioned that the sorting indexes adopted in the step a may, but not limited to, comprise the skill of riding. In this embodiment, the sorting index of the skill of riding is set with five scales, which respectively correspond to the greater extent A to the lesser extent E. In the step b), the scale selected for the skill of riding may be derived from self-estimation of the user, which means the user subjectively estimates his/her own skill of riding to determine the scale of the skill of riding. During the process of self-estimation, the user can estimate his/her own skill of riding according to some objective conditions thereof, such as how many years of experience of riding, having learned from a professional coach or not, being an amateur contestant or a professional contestant or not, and so on, so as to decide one scale from the first to fifth scales of the skill of riding.

Alternately, in the step a) the dealer in the bicycle saddle manufacturing or selling industry can specify the sorting index of the skill of riding by another index related to the skill of riding, such as user identity, experience of riding, and so on, so that the user can easily make the selection according the personal condition thereof. For example, according to user identities, the sorting index of the skill of riding may be set with five scales, which respectively correspond to the user identities of: kid, adult, athlete, amateur contestant, and professional contestant. Alternately, according to experience of riding, the sorting index of the skill of riding may be set with five scales, which respectively correspond to the experience of riding of: no experience, less than two years, two to five years, five to ten years, and more than ten years. In other words, any index related to the skill of riding, such as the aforesaid user identity or experience of riding, is within the scope of the skill of riding defined in the present invention.

c) Sort a fitting group from the groups by means of the selected scales of the sorting indexes in the step b).

Specifically speaking, this step may be performed by summing or averaging the numerical values of the selected scales of the sorting indexes in the step b) to obtain a sorting value, and then sorting the fitting group from the groups by means of the sorting value.

For the first application example 10 shown in FIG. 1 and the following table 2, which may represent a high level road rider, the sorting value obtained by averaging the numerical values of the selected scales of the five sorting indexes is 4.6. The sorting value of the first application example 10 should correspond to the group including the bicycle saddles having the minimal degree of weight and size, so that the bicycle saddles can meet the usage requirements of such road rider. Such road rider usually requires the maximum efficiency instead of comfortableness, and requires just appropriate support from the saddle because such road rider puts only a part of his weight on the saddle and most of his weight on the pedals and the handlebars.

For the second application example 20 shown in FIG. 1 and the following table 2, which may represent a casual rider or a casual e-bike rider who rides occasionally for transportation or an easy exercise, the sorting value obtained by averaging the numerical values of the selected scales of the five sorting indexes is 1.6. The sorting value of the second application example 20 should correspond to the group including the wider and more padded bicycle saddles, which meet the usage requirements of such casual rider by providing great support and comfortableness. Such casual rider usually puts most of his weight on the saddle and pedals relatively more lightly in pedaling force and shortly in traveling time.

TABLE 2

| | first | second |
|---|---|---|
| | application | application |
| | example | example |
| numerical value corresponding to | 5 | 2 |
| the scale of the bicycle type | | |
| numerical value corresponding to | 3 | 1 |
| the scale of the frequency of riding | | |
| numerical value corresponding to | 5 | 1 |
| the scale of the speed of riding | | |
| numerical value corresponding to | 5 | 2 |
| the scale of the distance of riding | | |
| numerical value corresponding to | 5 | 2 |
| the scale of the skill of riding | | |
| sorting value (average) | 4.6 | 1.6 |

In other words, in the step a) the dealer in the saddle manufacturing or selling industry can classify the bicycle saddles having various specifications into a plurality of groups, e.g. five groups, and set each group to correspond to a specific sorting value or a range of sorting value. For example, the sorting value corresponding to a fifth group is larger than 4.0 and smaller than or equal to 5.0, the sorting value corresponding to a fourth group is larger than 3.0 and smaller than or equal to 4.0, the sorting value corresponding to a third group is larger than 2.0 and smaller than or equal to 3.0, the sorting value corresponding to a second group is larger than 1.0 and smaller than or equal to 2.0, and the sorting value corresponding to a first group is equal to 1.0. Therefore, in the step c) the sorting value can be obtained by averaging the numerical values of the selected scales of the sorting indexes in the step b), and the sorting value can be used to sort the fitting group from the groups. It should be appreciated that the numerical values corresponding to the groups are not limited to that mentioned above. For example, the numerical values corresponding to the first to fifth groups may be set as that the sorting value corresponding to the first group is larger than or equal to 1.0 and smaller than 1.5, the sorting value corresponding to the second group is larger than or equal to 1.5 and smaller than 2.5, the sorting value corresponding to the third group is larger than or equal to 2.5 and smaller than 3.5, the sorting value corresponding to the fourth group is larger than or equal to 3.5 and smaller than 4.5, and the sorting value corresponding to the fifth group is larger than or equal to 4.5 and smaller than or equal to 5.0. Besides, the bicycle saddles in the same group may have different performance or particulars in specifications, as mentioned above. Therefore, after sorting out the fitting group from the groups through the aforesaid method, the selector can further choose the most conformable bicycle saddle with the usage requirements from the fitting group. In other words, the bicycle saddle selecting method of the present invention can simplify the process of selecting the bicycle saddle. For example, in the condition that the bicycle saddles are classified into five groups, sorting out the fitting group from the five groups through the method of the present invention will focus the selector on roughly 20% of all the available bicycle saddles. In this way, the selector only needs to select the most conformable bicycle saddle with the usage requirements from the small amount of bicycle saddles, instead of making the selection from numerous different bicycle saddles. Therefore, the process of selecting the bicycle saddle is relatively easier and time-saving through the bicycle saddle selecting method of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bicycle saddle selecting method comprising the steps of:
a) classifying bicycle saddles having various specifications into a plurality of groups, and setting a plurality of scales for each of a plurality of sorting indexes including a bicycle type, a frequency of riding, and at least one of a speed of riding and a distance of riding;
b) selecting one of the scales for each of the sorting indexes according to usage requirements; and
c) sorting a fitting group from the groups by means of the selected scales of the sorting indexes in the step b).

2. The bicycle saddle selecting method as claimed in claim 1, wherein each of the scales of the sorting indexes corresponds to a numerical value; in the step c), a sorting value is obtained by summing or averaging the numerical values of the selected scales of the sorting indexes in the step b), and the sorting value is used to sort the fitting group from the groups.

3. The bicycle saddle selecting method as claimed in claim 1, wherein the sorting index of the bicycle type is set with five said scales, which respectively correspond to the bicycle types of kid bicycle, city bicycle, sport bicycle, mountain bicycle, and road bicycle.

4. The bicycle saddle selecting method as claimed in claim 1, wherein the sorting index of the frequency of riding is set with five said scales, which respectively correspond to the frequencies of riding of random manner, monthly manner, weekly manner, twice a week, and daily manner.

5. The bicycle saddle selecting method as claimed in claim 1, wherein the sorting indexes comprise the speed of riding, which is set with five said scales respectively corresponding to speed ranges of 0-15 kilometers per hour, 15-20 kilometers per hour, 20-30 kilometers per hour, 30-40 kilometers per hour, and 40-50 kilometers per hour.

6. The bicycle saddle selecting method as claimed in claim 1, wherein the sorting indexes comprise the distance of riding, which is set with five said scales respectively corresponding to distance ranges of less than 5 kilometers, 5-15 kilometers, 15-30 kilometers, 30-50 kilometers, and 50-100 kilometers or more than 100 kilometers.

7. The bicycle saddle selecting method as claimed in claim 1, wherein the sorting indexes comprise both the speed of riding and the distance of riding.

8. The bicycle saddle selecting method as claimed in claim 1, wherein the sorting indexes further comprise skill of riding.

9. The bicycle saddle selecting method as claimed in claim 8, wherein the scale selected for the skill of riding in the step b) is derived from self-estimation of a user.

10. The bicycle saddle selecting method as claimed in claim 8, wherein the sorting index of the skill of riding is set with a plurality of scales according to a plurality of user identities.

11. The bicycle saddle selecting method as claimed in claim 10, wherein the sorting index of the skill of riding is set with five said scales, which respectively correspond to the user identities of kid, adult, athlete, amateur contestant, and professional contestant.

12. The bicycle saddle selecting method as claimed in claim 8, wherein the sorting index of the skill of riding is set with a plurality of scales according to user's experience of riding.

13. The bicycle saddle selecting method as claimed in claim 12, wherein the sorting index of the skill of riding is set with five said scales, which respectively correspond to the user's experience of riding of no experience, less than two years, two to five years, five to ten years, and more than ten years.
